(19) United States
(12) Patent Application Publication
(10) Pub. No.: US 2023/0176564 A1
(43) Pub. Date: Jun. 8, 2023

(54) APPARATUS AND METHOD FOR CONTROLLING VEHICLE

(71) Applicants: HYUNDAI MOTOR COMPANY, Seoul (KR); Kia Corporation, Seoul (KR)

(72) Inventor: Seung Hai HWANG, Hwaseong-si (KR)

(73) Assignees: HYUNDAI MOTOR COMPANY, Seoul (KR); Kia Corporation, Seoul (KR)

(21) Appl. No.: 17/988,134

(22) Filed: Nov. 16, 2022

(30) Foreign Application Priority Data
Dec. 6, 2021 (KR) 10-2021-0173163

(51) Int. Cl. G05D 1/00; H04W 4/40; H04W 4/80

(52) U.S. Cl. CPC G05D 1/0016; G05D 1/0022; H04W 4/40; H04W 4/80; G05D 2201/0213

(57) ABSTRACT

An apparatus of controlling a vehicle includes a communication device that communicates with a portable terminal, a sensor that detects a driving state and a surrounding state of the vehicle, and a controller that generates a second control signal different from a first control signal when the first control signal is not generated corresponding to the driving state, the surrounding state and an operation of an input device when a call signal is received at the portable terminal, the vehicle is in a driving state, and the input device is operated. Accordingly, even if a vehicle is not separately provided with an operation device for responding to the call signal received by the mobile terminal, the apparatus may respond to the call signal received by the portable terminal and be applied to low-cost vehicles, improving customer satisfaction and driving performance.

### CROSS-REFERENCE TO RELATED APPLICATION

The present application claims priority to Korean Patent Application No. 10-2021-0173163, filed on Dec. 6, 2021, the entire contents of which is incorporated herein for all purposes by this reference.

### BACKGROUND OF THE PRESENT DISCLOSURE

### Field of the Present Disclosure

The present disclosure relates to an apparatus and a method for controlling a vehicle.

### Description of Related art

Recently, to improve user convenience, a vehicle and a portable terminal may be interlocked, and may transmit/receive information related to the vehicle and information related to the portable terminal. Furthermore, the vehicle is separately provided with a dedicated operation device capable of controlling information related to a portable terminal, so that the operation of controlling the received information may be performed without the operation of the portable terminal.

However, because such a dedicated operation device leads to an increase in the manufacturing cost of a vehicle, a low-cost vehicle is often not provided with a dedicated operation device for controlling the information received from a portable terminal. Therefore, when the portable terminal receives a call signal while driving, a situation in which the driver operates a reception button of the portable terminal may occur, reducing driving safety. Accordingly, there is a need to provide a technology capable of responding to a call signal without operating a portable terminal even in a low-cost vehicle.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and method for controlling a vehicle configured for responding to a call signal even when an operation device for responding to a call signal received by a portable terminal is not separately provided.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus of controlling a vehicle includes a communication device that communicates with a portable terminal, one or more sensors that detects a driving state and a surrounding state of the vehicle, and a controller that generates a second control signal different from a first control signal when the first control signal is not generated in response to an operation of the input device corresponding to the driving state and the surrounding state even though a call signal is received at the portable terminal, the vehicle is in a driving state, and the input device is operated.

The controller may be configured to control not to perform a first function preset in the input device even when the input device is operated when the first control signal is not generated.

The controller may be configured to control to perform a second function different from a first function preset in the input device when the second control signal is generated in response to the operation of the input device.

The controller may perform a function corresponding to the call signal when the second control signal is generated in response to an operation of the input device.

The controller may be configured to control to perform a first function preset in the input device when the first control signal is generated in response to the operation of the input device according to the driving state and the surrounding state.

The controller may be configured to control not to generate the second control signal when the first control signal is generated in response to the operation of the input unit according to the driving state and the surrounding state.

The controller may be configured to control not to generate the first control signal and the second control signal in response to the operation of the input device when the call signal is not received at the portable terminal or the vehicle is not in a driving state.

The communication device may perform Bluetooth communication or Wi-Fi communication with the portable terminal.

The first control signal includes a control signal for performing a function preset in the input device.

The second control signal includes a control signal for performing a function in response to the call signal.

According to another aspect of the present disclosure, a method of controlling a vehicle includes determining whether a call signal is received by a portable terminal interlocked with the vehicle, determining whether the vehicle is in a driving state, and generating a second control signal different from a first control signal when the first control signal is not generated in response to an operation of the input device corresponding to the driving state and the surrounding state detected by one or more sensors when the input device is operated.

The method may further include controlling not to perform a first function preset in the input device when the input device is operated when the first control signal is not generated.

The method may further include controlling to perform a second function different from a first function preset in the input device when the second control signal is generated corresponding to an operation of the input device.

The method may further include performing a function corresponding to the call signal when the second control signal is generated in response to the operation of the input device.

The method may further include controlling to perform a first function preset in the input device when the first control signal is generated in response to the operation of the input device according to the driving state and the surrounding state.

The method may further include controlling not to generate the second control signal when the first control signal is generated in response to the operation of the input device according to the driving state and the surrounding state.

The method may further include controlling not to generate the first control signal and the second control signal in response to the operation of the input device when the call signal is not received at the portable terminal or the vehicle is not in a driving state.

The method may further include, wherein the portable terminal interworks with the vehicle through Bluetooth communication or Wi-Fi communication.

The first control signal includes a control signal for performing a function preset in the input device.

The second control signal includes a control signal for performing a function in response to the call signal.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating the configuration of an apparatus of controlling a vehicle according to an exemplary embodiment of the present disclosure;

FIG. 2 and FIG. 3 are views exemplarily illustrating an input device according to an exemplary embodiment of the present disclosure;

FIG. 4 is a flowchart illustrating a method of controlling a vehicle according to an exemplary embodiment of the present disclosure; and

FIG. 5 is a block diagram illustrating a computing system for executing a method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

In describing the components of the exemplary embodiment according to an exemplary embodiment of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

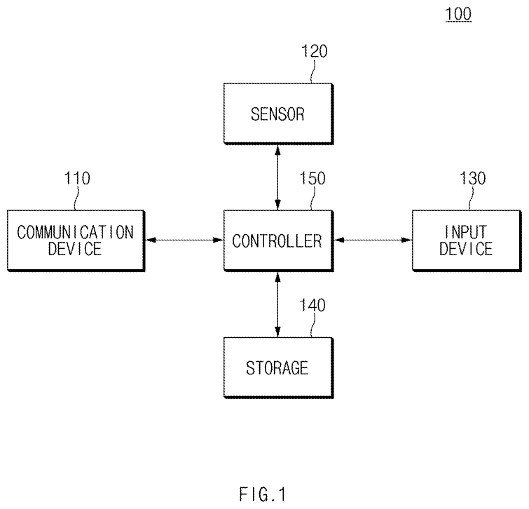

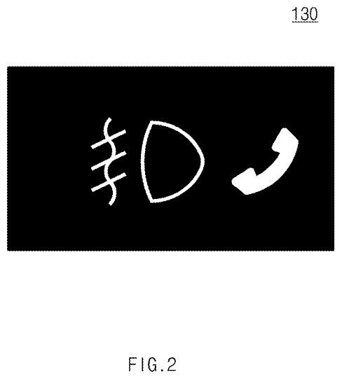

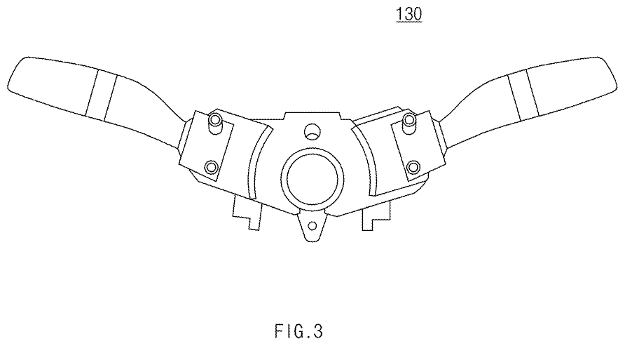

FIG. 1 is a block diagram illustrating the configuration of an apparatus of controlling a vehicle according to an exemplary embodiment of the present disclosure. FIG. 2 and FIG. 3 are views exemplarily illustrating an input device according to an exemplary embodiment of the present disclosure.

As shown in FIG. 1, an apparatus 100 for controlling a vehicle may include a communication device 110, a sensor 120, an input device 130, storage 140, and a controller 150.

The communication device 110 may wirelessly communicate with a portable terminal. According to an exemplary embodiment of the present disclosure, the communication device 110 may perform Wi-Fi communication or Bluetooth communication.

The sensor 120 may detect the driving state and surrounding state of a vehicle. According to an exemplary embodiment of the present disclosure, the sensor 120 may include a speed sensor configured for detecting the speed of a vehicle and a temperature sensor configured for detecting external temperature. Furthermore, the sensor 120 may include a rain sensor and an illuminance sensor.

The input device 130 may receive an input signal corresponding to an operation, motion, or voice of a driver. According to an exemplary embodiment of the present disclosure, the input device 130 may be implemented with a switch, a scroll wheel, a button, a knob, a touch screen, a touch pad, a lever, a track ball, or the like that can be operated by a driver, or may be implemented with at least one of a motion sensor configured for detecting a motion or a voice recognition sensor configured for detecting voice of an occupant, or a combination thereof.

According to an exemplary embodiment of the present disclosure, the input device 130 may transmit an input signal to the controller 150. The controller 150 may generate a control signal (a first control signal) for allowing a function preset in the input device 130 to be performed in response to the input signal.

As an exemplary embodiment of the present disclosure, the input device 130 may include a fog lamp button including a receiver display as shown in FIG. 2, and the controller 150 may generate a control signal for allowing a function (of turning ON/OFF a fog lamp) preset in the fog lamp button to be performed corresponding to an input signal by operation of the fog lamp button.

Furthermore, as shown in FIG. 3, the input device 130 may include a multi-function switch. The controller 150 may generate a control signal for performing a function (e.g., wiper operation, headlight ON/OFF, or the like) preset in the multi-function switch in response to an input signal by the operation of the multi-function switch.

Furthermore, the input device 130 may include a door open switch. The controller 150 may generate a control signal for performing a function (door open) preset in the door open switch in response to an input signal by the operation of a window open/close switch.

The input device 130 is not limited to the above-described embodiment, and when the input device 130 is provided at a location in the vehicle to be easily operated by a driver, the input device 130 may be replaced with another switch or button.

The storage 140 may store at least one algorithm for performing operations or executions of various commands for the operation of an apparatus of controlling a vehicle according to an exemplary embodiment of the present disclosure. The storage 140 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The controller 150 may be implemented with various processing devices such as a microprocessor and the like in which a semiconductor chip configured for performing operations or executions of various commands is built-in, and may control operations of the apparatus of controlling a vehicle according to an exemplary embodiment of the present disclosure.

The controller 150 may communicate with a portable terminal to interwork. The controller 150 may determine whether a call signal is received at the portable terminal and determine whether the vehicle is in a driving state.

When it is determined that the portable terminal receives a call signal and the vehicle is in a driving state, the controller 150 may determine whether a first signal for performing a function preset in the input device 130 when operating the input device 130 based on the driving state and surrounding state obtained by the sensor 120 is generated.

According to an exemplary embodiment of the present disclosure, the controller 150 may generate a control signal (first control signal) for performing a function (fog lamp ON/OFF) preset in a fog lamp switch when a preset first condition (e.g., the vehicle speed is greater than or equal to a reference speed (50 km/h), and the external temperature exceeds a first temperature (e.g., 20 degrees) or less than a second temperature (e.g., 0 degrees)) is satisfied when the input device 130 is operated. Meanwhile, when the preset first condition is not satisfied, the controller 150 may not generate a control signal for performing a preset function even when the input device 130 is operated.

Accordingly, the controller 150 may determine whether the first control signal is generated when the input device is operated based on whether the first condition is satisfied, and the controller 150 may determine that the first control signal is not generated when the first condition is not satisfied.

According to another exemplary embodiment of the present disclosure, when a preset second condition (rainy condition) is satisfied when the input device 130 is operated, the controller 150 may generate a control signal (first control signal) for performing a function (wiper operation) preset to the multi-function switch. Meanwhile, when the preset second condition is not satisfied, the controller 150 may not generate a control signal for performing a preset function even when the input device 130 is operated.

Accordingly, the controller 150 may determine whether the first control signal is generated when the input device 130 is manipulated based on whether the second condition is satisfied. When the second condition is not satisfied, the controller 150 may determine that the first control signal is not generated.

According to another exemplary embodiment of the present disclosure, when a preset third condition (the illuminance value outside the vehicle is less than a reference value) is satisfied when the input device 130 is operated, the controller 150 may generate a control signal (first control signal) for performing a function (headlight on) preset in the multi-function switch. Meanwhile, when the third condition is not satisfied, the controller 150 may not generate a control signal for performing a preset function even if the input device 130 is operated.

Therefore, the controller 150 may determine whether the third condition is satisfied. The controller 150 may determine whether the first control signal is generated when the input device 130 is manipulated, based on whether the third condition is satisfied. When the third condition is not satisfied, the controller 150 may determine that the first control signal is not generated.

According to another exemplary embodiment of the present disclosure, when it is determined that the vehicle is in a driving state, the controller 150 may not generate a control signal for performing a function (door open) preset in a door open switch.

After the portable terminal receives a call signal and it is determined that the vehicle is in a driving state, when the input device 130 is operated and it is determined that the first control signal for performing a function preset in the input device 130 is not generated, the controller 150 may generate a second control signal.

When it is determined that the first control signal for performing a function preset in the input device 130 is not generated, even though the input device 130 is operated, the controller 150 may control not to perform a first function set in the input device 130. When the second control signal is generated in response to the operation of the input device 130, the controller 150 may control to perform a second function preset in the input device 130 different from the first function.

According to an exemplary embodiment of the present disclosure, when the first control signal is not generated, the controller 150 may control to perform a function in response to the call signal received by the portable terminal corresponding to the operation of the input device 130.

When it is determined that the first control signal for performing a function preset in the input device 130 is generated, the controller 150 may control to perform a function (first function) preset in the input device 130. When the first control signal is generated, the controller 150 may control not to generate the second control signal.

Meanwhile, when it is determined that a call signal is not received at the portable terminal or that the vehicle is not in a driving state, the controller 150 may control not to generate the first control signal and the second control signal.

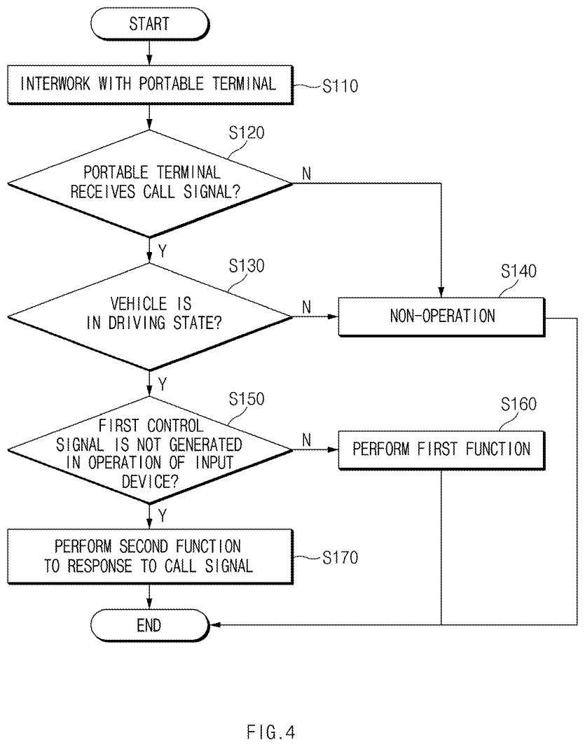

FIG. 4 is a flowchart illustrating a method of controlling a vehicle according to an exemplary embodiment of the present disclosure.

As shown in FIG. 4, in S110, the controller 150 may control to communicate and interwork with a portable terminal.

In S120 and S130, the controller 150 may determine whether the portable terminal receives a call signal and determine whether the vehicle is in a driving state.

When it is determined in S120 that the portable terminal does not receive the call signal (N), or when it is determined in S130 that the vehicle is not in a driving state (N), in S140, the first control signal and the second control signal may not be generated in response to the operation of the input device 130, and the function performed in response to the operation of the input device 130 may not be performed even though the input device is operated.

When it is determined in S120 that the portable terminal receives a call signal (Y), and when it is determined in S130 that the vehicle is in a driving state (Y), in S150, the controller 150 may determine whether the first control signal for performing a function preset in the input device 130 is not generated when the input device 130 is operated, based on the driving state and surrounding state obtained by the sensor 120.

When the first condition (e.g., the vehicle speed is greater than or equal to the reference speed (50 km/h), and the external temperature exceeds the first temperature (e.g., 20 degrees) or does not meet the second temperature (e.g., 0 degrees)) is not satisfied, the controller 150 may not generate a control signal (first control signal) for performing a function (fog lamp ON/OFF) preset in the input device 130.

Furthermore, when the second condition (rainy condition) is not satisfied, the controller 150 may not generate a control signal (first control signal) for performing a function (wiper operation) preset in the input device 130.

Furthermore, when the third condition (the illuminance value outside the vehicle is less than a reference value) is not satisfied, the controller 150 may not generate a control signal (first control signal) for performing a preset function (headlight ON/OFF).

Furthermore, when it is determined that the vehicle is in a driving state, the controller 150 may not generate a control signal (first control signal) for performing a function (door open) preset in the door open switch.

Accordingly, when it is determined in S150 that the above-described first condition is not satisfied, the above-described second condition is not satisfied, the above-described third condition is not satisfied, or the vehicle is in a driving state, it is possible to determine that the first control signal for performing a function preset in the input device 130 is not generated.

When it is determined in S150 that the first control signal for performing a function preset in the input device 130 is not generated (or generated) when the input device 130 is operated (N), the controller 150 may control to perform the first function preset in the input device 130 in S160. When the first control signal is generated, the controller 150 may control not to generate the second control signal.

When it is determined in S150 that the first control signal for performing a function preset in the input device 130 is not generated when the input device 130 is operated (Y), even when the input device 130 is operated, the controller 150 may control not to perform the first function preset in the input device 130 and generate the second control signal.

When the second control signal is generated in response to the operation of the input device 130, in S170, the controller 150 may control to perform the second function different from the first function preset in the input device 130. According to the exemplary embodiment of the present disclosure, in S170, the controller 150 may control to perform a function of responding to a call signal received by the portable terminal in response to the operation of the input device 130.

When it is determined that the first control signal for performing a function preset in the input device 130 is generated when the input device 130 is operated, the controller 150 may control to perform a function (first function) preset in the input device 130, and control not to generate the second signal when the first control signal is generated.

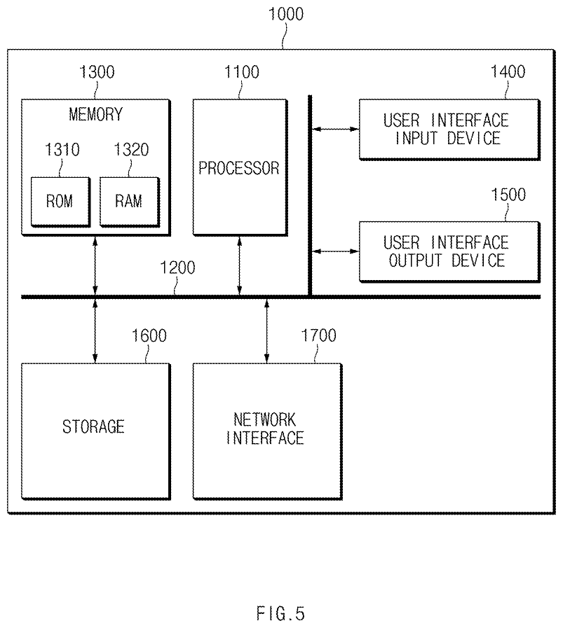

FIG. 5 is a block diagram illustrating a computing system for executing a method according to an exemplary embodiment of the present disclosure.

Referring to FIG. 5, a computing system 1000 may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the exemplary embodiments of the present disclosure, the apparatus and method for controlling a vehicle can respond to the call signal received by the portable terminal even if the vehicle is not separately provided with an operation device for responding to the call signal received by the mobile terminal, and thus may be applied to low-cost vehicles, improving customer satisfaction and driving performance.

Although exemplary embodiments of the present disclosure have been described for illustrative purposes, those skilled in the art will appreciate that various modifications, additions and substitutions are possible, without departing from the scope and spirit of the present disclosure.

In various exemplary embodiments of the present disclosure, the control device may be implemented in a form of hardware or software, or may be implemented in a combination of hardware and software.

The scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium having such software or commands stored thereon and executable on the apparatus or the computer.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of controlling a vehicle, the apparatus comprising:
a communication device configured to communicate with a portable terminal;
one or more sensors configured to detect a driving state and a surrounding state of the vehicle; and
a controller electrically connected to the communication device, the one or more sensors and an input device and configured to generate a second control signal different from a first control signal when the first control signal is not generated in response to an operation of the input device corresponding to the driving state and the surrounding state even though a call signal is received at the portable terminal, the vehicle is in the driving state, the input device is operated.

2. The apparatus of claim 1, wherein the controller is configured to:
control not to perform a first function preset in the input device even when the input device is operated when the first control signal is not generated.

3. The apparatus of claim 1, wherein the controller is configured to:
control to perform a second function different from a first function preset in the input device when the second control signal is generated in response to the operation of the input device.

4. The apparatus of claim 1, wherein the controller is configured to:
perform a function in response to the call signal when the second control signal is generated corresponding to the operation of the input device.

5. The apparatus of claim 1, wherein the controller is configured to:
control to perform a first function preset in the input device when the first control signal is generated in response to the operation of the input device according to the driving state and the surrounding state.

6. The apparatus of claim 1, wherein the controller is configured to:
control not to generate the second control signal when the first control signal is generated in response to the operation of the input device according to the driving state and the surrounding state.

7. The apparatus of claim 1, wherein the controller is configured to:
control not to generate the first control signal and the second control signal in response to the operation of the input device when the call signal is not received at the portable terminal or the vehicle is not in the driving state.

8. The apparatus of claim 1, wherein the communication device is configured to:
perform Bluetooth communication or Wi-Fi communication with the portable terminal.

9. The apparatus of claim 1, wherein the first control signal includes a control signal for performing a function preset in the input device.

10. The apparatus of claim 1, wherein the second control signal includes a control signal for performing a function in response to the call signal.

11. A method of controlling a vehicle, the method comprising:
determining, by a controller, whether a call signal is received by a portable terminal interlocked with the vehicle;
determining, by the controller, whether the vehicle is in a driving state; and
generating, by the controller, a second control signal different from a first control signal when the first control signal is not generated in response to an operation of an input device corresponding to the driving state and a surrounding state detected by one or more sensors electrically connected to the controller when the input device is operated.

12. The method of claim 11, further including:
controlling, by the controller, not to perform a first function preset in the input device when the input device is operated when the first control signal is not generated.

13. The method of claim 11, further including:
controlling, by the controller, to perform a second function different from a first function preset in the input device when the second control signal is generated in response to the operation of the input device.

14. The method of claim 13, further including:
performing, by the controller, a function corresponding to the call signal when the second control signal is generated in response to the operation of the input device.

15. The method of claim 11, further including:
controlling, by the controller, to perform a first function preset in the input device when the first control signal is generated in response to the operation of the input device according to the driving state and the surrounding state.

16. The method of claim 11, further including:
controlling, by the controller, not to generate the second control signal when the first control signal is generated in response to the operation of the input device according to the driving state and the surrounding state.

17. The method of claim 11, further including:
controlling, by the controller, not to generate the first control signal and the second control signal in response to the operation of the input device when the call signal is not received at the portable terminal or the vehicle is not in the driving state.

18. The method of claim 11, wherein the portable terminal interworks with the vehicle through Bluetooth communication or Wi-Fi communication.

19. The method of claim 11, wherein the first control signal includes a control signal for performing a function preset in the input device.

20. The method of claim 11, wherein the second control signal includes a control signal for performing a function in response to the call signal.
